(19) United States
(12) Patent Application Publication
(10) Pub. No.: US 2011/0115748 A1
(43) Pub. Date: May 19, 2011

(54) Infrared Touch Screen

(75) Inventor: Lin Xu, Shanghai (CN)

(73) Assignee: AMLOGIC CO., LTD., Santa Clara, CA (US)

(21) Appl. No.: 12/621,491

(22) Filed: Nov. 18, 2009

(51) Int. Cl. G06F 3/042

(52) U.S. Cl. 345/175

(57) ABSTRACT

A touch screen system comprises the following: a detection area having at least two sides; light transmitters (“LTs”) disposed on the sides; and light receivers (“LRs”) disposed on the sides, wherein the LTs and the LRs are paired where one of the LTs is paired with one of the LRs, forming transmitter-receiver pairs, wherein the transmitter-receiver pairs are positioned on the sides, where the light transmitter and the light receiver of anyone of the transmitter-receiver pairs are disposed on different ones of the sides, wherein selected ones of the transmitter-receiver pairs are partitioned into two or more groups as a function of the respective positions of the transmitter-receiver pairs along the sides, and wherein one of the groups is activated at a given time.

### FIELD OF INVENTION

This invention relates generally to touch screens, and, more particularly, to scanning methods and systems for infrared ray (“IR”) touch screens.

### BACKGROUND

Touch screens are used in conjunction with a variety of display devices, including cathode ray tubes (“CRTs”) and liquid crystal displays (“LCDs”), as a means of inputting information into a data processing system. When a touch screen is placed over a display or integrated into the display, the touch screen allows a user to select a displayed icon or element by touching the screen in a location corresponding to the selected icon or element.

Touch screens have become common place in a variety of different applications including, for example, point-of-sale applications such as cash registers at fast-food restaurants, point-of-information applications such as department store information kiosks, ticketing applications such as airline-ticket kiosks, and other applications.

There are typically four types of touch screen classifications into which most touch screens can be largely classified, such as a resistance film type touch screen, an electrostatic capacity type touch screen, an ultrasonic wave reflection type touch screen, and an optical type touch screen using infrared light, microwaves, or other electromagnetic waves.

With respect to the resistance film type touch screens and the electrostatic capacity type touch screens, these touch screens determine a position of an object on the touch screens by detecting a variance in resistance and/or in electrostatic capacity on the touch screen. The resistance and electrostatic capacity are obtained when a point of contact is generated by the user touching a portion of the display.

In addition, the ultrasonic wave reflection type touch screens and the optical type touch screens function by the formation of an array of ultrasonic waves or light beams. The ultrasonic wave reflection type touch screens and optical type touch screens determine a position on their respective screens based on the detection or the non-detection of beams on a lattice.

For instance, an optical type touch screen has sets of paired light transmitters and light receivers for covering the display of the touch screen with crossed light beams along an x-axis and a y-axis. The beams can be sequentially activated to determine if any beams are blocked. If a broken beam in the x-axis or the y-axis is detected during this scanning operation, then that information is used to determine the x-axis or y-axis location for a corresponding object in proximity with the touch screen.

FIG. 1 illustrates a conventional structure for an optical touch screen. A touch screen has a detection area 100, where the detection area 100 is covered by a lattice of light beams emitted from transmitters 111 and 122 to receivers 112 and 121. The receivers 112 and 121 are positioned along the side of the detection area 100 to correspond to the respective transmitters 111 and 122; thus transmitters and receivers are paired to one another. The transmitters 111 and 122 emit beams in the direction toward their corresponding receivers 112 and 121, such that the emitted beams form a lattice.

If a receiver does not detect light from its paired transmitter, then a touch event is triggered. For instance, if the user puts an object 101 (e.g., the user's finger, a stylus, or other object), on the detection area 100, then some beams are intercepted (e.g., absorbed, reflected, refracted, etc.) by the object 101. The result is that the beams that were intercepted by the object 101 are not detected by the corresponding receivers 112 and 121. The touch screen determines the x-axis location and the y-axis location based on the receivers that did not detect their paired light.

However, conventional optical touch screens are problematic in that the receivers may detect incidental beams not emitted by their paired transmitters since beams from adjacent transmitters may be detected by non-paired receivers; thus, leading to non-detection of an object on or in proximity to the touch screens.

FIG. 2 illustrates a situation where light beams emitted from an adjacent transmitter are received by a non-paired receiver. A transmitter T1 is paired with a receiver R1, a transmitter T2 is paired with a receiver R2; a transmitter T3 is paired with a receiver R3; a transmitter T4 is paired with a receiver R4; and so on and so forth. When an object 201 is placed in contact with the detection area 100, blocking the transmitter-receiver pair T3 and R3, the touch screen may determine that a touch event has occurred since the receiver R3 did not receive light from the paired transmitter T3.

However, light from transmitters adjacent to the transmitter T3 (e.g., the transmitters T2 and T4) may also be received by the receiver R3 since light waves (e.g., infrared beams, light beams, radio waves and other electromagnetic waves) are emitted from the source at various angles. The touch screen may detect received light at the receiver R3 from an adjacent transmitter to the transmitter T3, and process that light as if it was from its paired transmitter T3. Thus, the object 201 is not detected since the blockage of the transmitter-receiver pair T3 and R3 is not sensed by the touch screen.

Thus, systems for infrared touch screens are needed to limit the amount of light received by a receiver from non-paired transmitters.

### SUMMARY OF INVENTION

An object of this invention is to provide systems for improving reliability for detecting touch events by an optical touch screen.

Another object of this invention is to provide systems for limiting the angle at which light is emitted from a transmitter of an optical touch screen and for limiting the angle at which light is received by a receiver of the optical touch screen.

Yet another object of this invention is to provide methods for group scanning of paired transmitters and receivers of an optical touch screen to improve reliability for detecting touch events.

Briefly, a touch screen system comprises the following: a detection area having at least two sides; light transmitters (“LTs”) disposed on the sides; and light receivers (“LRs”) disposed on the sides, wherein the LTs and the LRs are paired where one of the LTs is paired with one of the LRs, forming transmitter-receiver pairs, wherein the transmitter-receiver pairs are positioned on the sides, where the light transmitter and the light receiver of anyone of the transmitter-receiver pairs are disposed on different ones of the sides, wherein selected ones of the transmitter-receiver pairs are partitioned into two or more groups as a function of the respective positions of the transmitter-receiver pairs along the sides, and wherein one of the groups is activated at a given time.

An advantage of this invention is that systems for improving reliability for detecting touch events by an optical touch screen are provided.

Another advantage of this invention is that systems for limiting the angle at which light is emitted from a transmitter of an optical touch screen and for limiting the angle at which light is received by a receiver of the optical touch screen are provided.

Yet another advantage of this invention is that methods for group scanning of paired transmitters and receivers of an optical touch screen are provided to improve reliability for detecting touch events.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a prior art system for detecting touch events by an optical touch screen where transmitters are placed on one side of the touch screen and receivers are placed on the opposite side.

FIG. 2 illustrates a prior art system for detecting touch events by an optical touch screen where transmitters are placed on one side of the touch screen and receivers are placed on the opposite side.

FIG. 3a illustrates a system of the present invention for detecting touch events by an optical touch screen where transmitters and receivers are positioned according to an alternating scheme on each side of the touch screen.

FIGS. 3b-3d illustrate various alternating schemes for transmitters and receivers.

FIG. 4 illustrates a system of the present invention for detecting touch events by an optical touch screen where light guides are positioned in front of transmitters and receivers.

FIGS. 5a-5c illustrate a system of the present invention for detecting touch events by an optical touch screen where transmitter and receiver pairs are assigned to groups according to a grouping scheme, an alternating scheme, and light guides scheme.

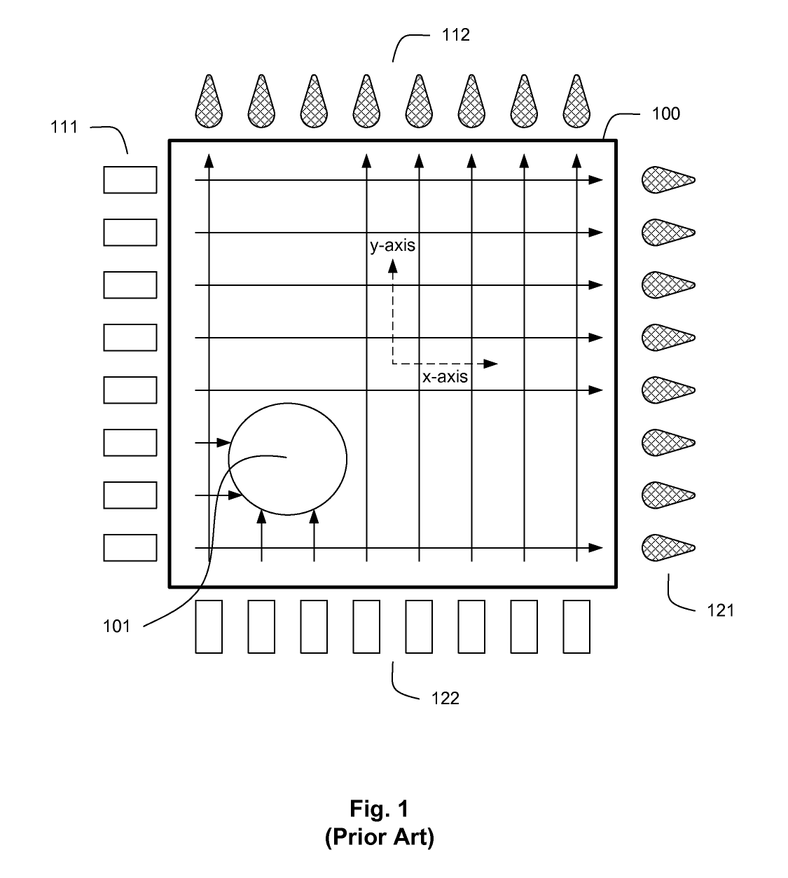

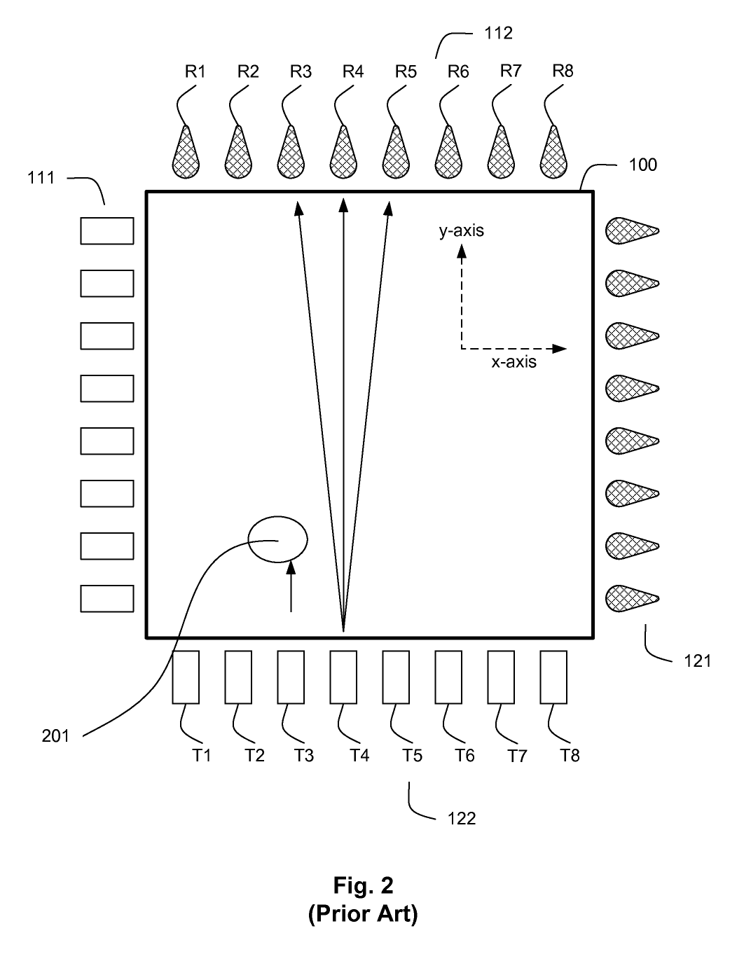

### DETAILED DESCRIPTION OF THE PREFERRED EMBODIMENTS

In order to aid in the understanding of the present invention, optical touch screens will be used to illustrate various embodiments of the present invention. However, it is not intended to limit the invention to optical touch screens. In fact, the invention may apply to any touch screen that uses electromagnetic (“EM”) waves (e.g., visible light beams, infrared waves, microwaves, radio waves, sonar waves, and other electromagnetic waves) for detecting touch events.

### Alternating Scheme

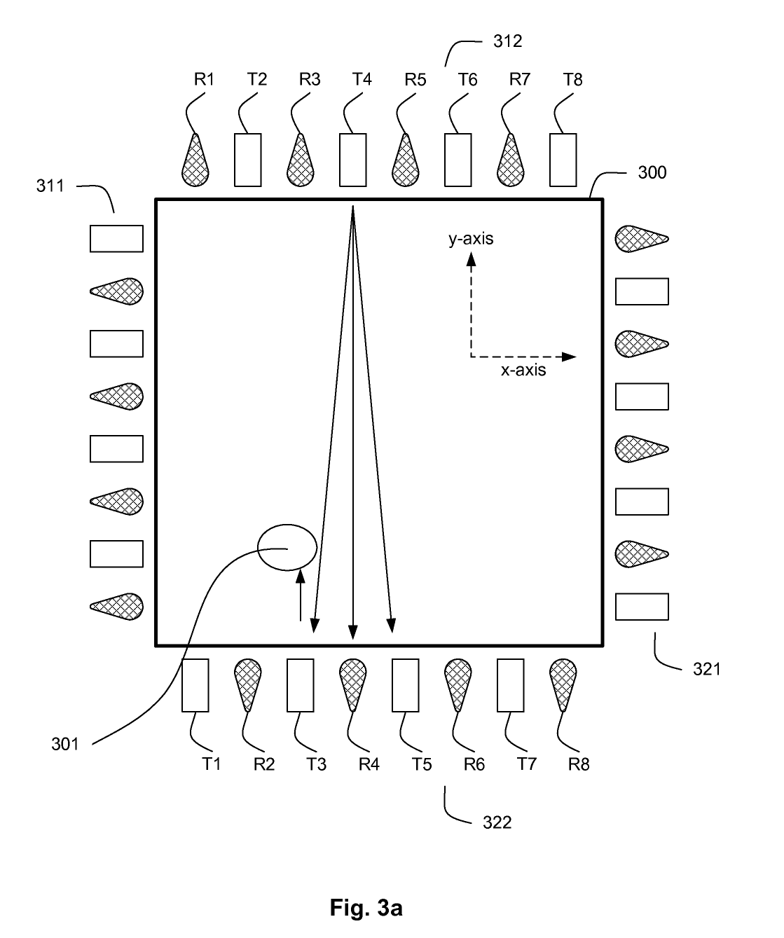

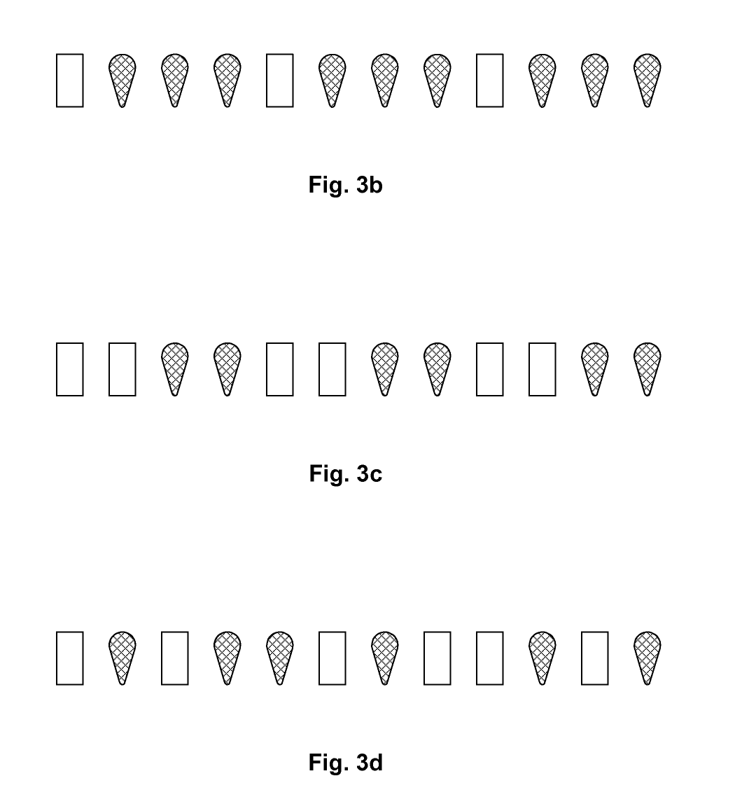

FIG. 3a illustrates a system of the present invention for detecting touch events by an optical touch screen where transmitters and receivers are positioned in alternating order on each side of a detection area of the touch screen. A touch screen can have transmitters and receivers positioned along the left side 311 of the touch screen in alternating order. The right side 321 of the touch screen also can have transmitters and receivers positioned in alternating order. For a transmitter positioned on the left side 311, there is a paired receiver positioned on the right side 321 for detecting light emitted from the transmitter. In addition, for a receiver positioned on the left side 311, there is a paired transmitter positioned on the right side 321 to transmit light to the receiver. Generally, the light transmitters and the light receivers are paired according to a one-to-one mapping of one of the light transmitters to one of the light receivers.

Similarly, the top side 312 of the touch screen and the bottom side 322 of the touch screen can have paired transmitters and receivers arranged in a similar manner, where transmitters and receivers are positioned in alternating order along each side. For instance, the top side 312 of the touch screen has the following order from a first end of the top side 312, which is adjacent to the left side 311, to a second end of the top side 312, which is adjacent to the right side 321, of a receiver R1, a transmitter T2, a receiver R3, a transmitter T4, a receiver R5, a transmitter T6, a receiver R7, and a transmitter T8. The bottom side 322 of the touch screen has the following order from a first end of the bottom side 322, which is adjacent to the left side 311, to a second end of the bottom side 322, which is adjacent to the right side 321, of a transmitter T1, a receiver R2, a transmitter T3, a receiver R4, a transmitter T5, a receiver R6, a transmitter T7, and a receiver R8. Additionally, the top receiver R1 is paired with the bottom transmitter T1; the top transmitter T2 is paired with the bottom receiver R2; the top receiver R3 is paired with the bottom transmitter T3; the top transmitter T4 is paired with the bottom receiver R4; and so on. The other receivers R5-R8 and transmitters T5-T8 can also be paired to transmit and receive light to each other.

The touch screen may have a detection area 300 for sensing touch events. The detection area 300 can be mapped to a display of the touch screen. Generally, a grid of light beams is projected across the detection area 300 of the touch screen by the transmitters, e.g., light emitting diodes or other EM emitting devices, and received by the corresponding paired receivers, e.g., phototransistors or other EM detecting devices. Each optical beam is transmitted and received within the same plane, which can be located slightly above the top surface of the display of the touch screen.

When an object 301 is placed on or in proximity to the detection area 300 and blocks the light emitted from a transmitter-receiver pair, then a touch event is triggered. The x-axis location of the object 301 on the touch sensitive area 300 can be identified by determining which of the transmitter-receiver pairs positioned along the top side 312 and the bottom side 322 are blocked. Likewise, the y-axis location of the object 301 on the touch sensitive area 300 can be identified by determining which of the transmitter-receiver pairs, positioned along the left side 311 and the right side 321, are blocked.

In this illustration, light emitted by the transmitter T3 is blocked by the object 301 from reaching its paired receiver R3. Thus, the x-axis location for the object 301 can be determined from the position of the blocked transmitter-receiver pair. Similarly, the y-axis location for the object 301 can be determined from the position of a blocked transmitter-receiver pair. Thus, the touch screen system can detect the blockage and indicate the corresponding position of the object 301 on the detection area 300. The position of the object 301 can then be processed for use by an application.

By employing an alternating scheme for the transmitters and receivers of the touch screen, a receiver may reduce or eliminate the amount of extraneous light (e.g., light not emitted by its paired transmitter) incident on the receiver by spacing transmitter-receiver pairs further away from each other.

Furthermore, a transmitter-receiver pair can be spaced a distance away from an adjacent transmitter-receiver pair on the same side such that the receivers will not detect extraneous light from non-paired transmitters. For instance, the pair T2 and R2 and the pair T4 and R4 are positioned adjacent to each other, where both the transmitters T2 and T4 are positioned on the same side 312 and both the receivers R2 and R4 are positioned on the same side 322. The two pairs are spaced away from each other such that the receiver R2 cannot detect the light emitted from the transmitter T4. In addition, the receiver R4 cannot detect the light emitted from the transmitter T2. However, by increasing the space between transmitters and receivers on the same side, the sensitivity of the detection area 300 decreases since there are less pairs of transmitter and receivers for the given detection area 300.

The gap between two adjacent pairs of transmitters and receivers can be filled by a transmitter-receiver pair that is arranged to emit light in the opposite direction from the two adjacent pairs. Thus, each side will appear to have alternating transmitters and receivers. By alternating the transmitters and receivers on the sides of the touch sensitive area 300, the resolution can be greatly improved since transmitters and receivers can be positioned closer together while still avoiding extraneous light from non-paired transmitters.

Other alternating schemes for transmitters and receivers can be employed to mitigate the amount of extraneous light on any one receiver.

FIG. 3b illustrates an arrangement of transmitters and receivers according to an alternating scheme of the present invention. In this scheme, the order of transmitters and receivers along a side of a detection area can be the following of a transmitter, a receiver, a receiver, a receiver, a transmitter, a receiver, a receiver, a receiver, a transmitter, a receiver, a receiver, a receiver, and so on.

FIG. 3c illustrates an arrangement of transmitters and receivers according to an alternating scheme of the present invention. In this scheme, the order of transmitters and receivers along a side of a detection area can be the following of a transmitter, a transmitter, a receiver, a receiver, a transmitter, a transmitter, a receiver, a receiver, a transmitter, a transmitter, a receiver, a receiver, and so on.

FIG. 3d illustrates an arrangement of transmitters and receivers according to an alternating scheme of the present invention. In this scheme, the order of transmitters and receivers along a side of a detection area can be the following of a transmitter, a receiver, a transmitter, a receiver, then the order of transmitters and receivers is reversed with a receiver, a transmitter, a receiver, a transmitter, the order is reversed again starting with a transmitter, and so on and so forth. This scheme may be herein referred to as a reverse-alternating order.

There are an infinite number of transmitter and receiver combinations that can be used in accordance with an alternating scheme of the present invention. It is to be understood that all variations of an alternating scheme for the arrangement of transmitters and receivers can be employed.

### Light Guides

In addition (or alternatively) to an alternating scheme for transmitters and receivers on each side of a touch screen, the touch screen can have light guides to direct emitted light from a transmitter and to reduce extraneous light received by a receiver. A light guide can be formed by placing a hollow structure in front of a transmitter or receiver to focus the emitted light from the transmitter to its paired receiver. The light guide can extend from the transmitter or receiver to the detection area. Light can travel to the receiver or from the transmitter via the hollow opening in the light guide. Therefore, the hollow opening can be aligned in the plane of the detection area, so that the transmitters of the touch screen can transmit light to their paired receivers on the touch screen.

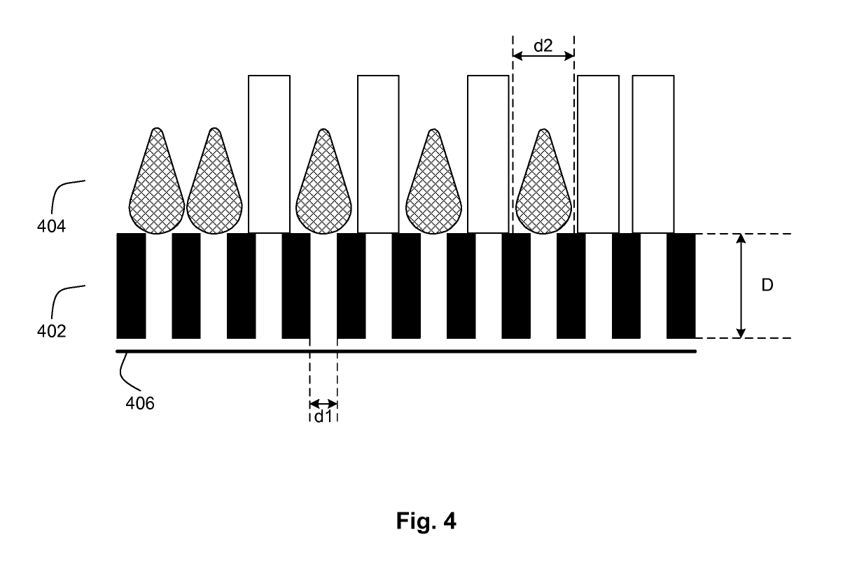

The length of the light guide, D shown in FIG. 4, can be selected to limit the various angles at which light can enter or exit the light guide. The length of a light guide can also be carefully selected to minimize the space needed to house the light guides and to maximize the attenuation of light at certain angles entering and/or exiting the light guide. A width for the hollow opening, d1, of the light guide can also be determined to attenuate the amount of light at certain angles entering and exiting the tube. The height of the light guide, which is perpendicular from the plane of the detection area, can be variable since the transmitters and receivers only detect an object in (or in close proximity to) the plane of the detection area (and not along the perpendicular distance from the plane of the detection area).

The cross section of the hollow structure of the light guides can be various shapes, including an ellipse, a rectangle, a polygon, an irregular shape, or other shapes. Additionally, the light guides can be slits formed by two plates, where the plates can be mounted onto the touch screen along the sides of the detection area of the touch screen. Furthermore, the material of the light guides can be any material that is substantially opaque for the particular type of light used by the transmitters of the touch screen.

FIG. 4 illustrates a light guide for an optical touch screen. Light guides 402 can be positioned along the plane of the detection area of a touch screen, and along a side 406 of the detection area of the touch screen. Preferably, the light guides 402 are positioned along the front region of a row of transmitters and receivers 404 to guide light emitted from the transmitters and to receive the emitted light by the receivers. The width of a light guide, d1, and a length of the light guide, D, can be selected to further reduce the extraneous light. Furthermore, the side of the detection area of the touch screen can be partitioned into several segments with a distance, d2, for mounting a transmitter or receiver.

### Grouping Scheme

A group scanning scheme can be used in conjunction with an alternating scheme and light guides to further reduce the amount of extraneous light and to improve the resolution of the touch sensitive area. The transmitter-receiver pairs are partitioned into groups (e.g., group 1, group 2, group 3, group 4, and so on). The transmitter-receiver pairs in the same group can be turned off and on as a group. When one group is on, the other groups are off.

The groups can also have a group order, which can identify the order in which transmitter-receiver pairs are partitioned into groups and/or identify the order in which the groups are activated.

Generally, neighboring transmitter-receiver pairs can be placed in different groups, so that if a transmitter-receiver pair is active (i.e., on), then its adjacent transmitter-receiver pairs are inactive (i.e., off). Thus, the groups are activated as a function of the sequential positions of the transmitter-receiver pairs. In so doing, the amount of extraneous light is decreased since adjacent transmitters are inactive. By turning off adjacent transmitter-receiver pairs when an active transmitter-receiver pair is on, transmitter-receiver pairs can be positioned closer together along the sides of the detection area of the touch screen; thus improving touch screen sensitivity. The groups can be activated in group order, random order, or any other order.

Thus, a gap of deactivated transmitter-receiver pairs between any two adjacent active transmitter-receiver pairs in the same group is up to the number of other groups (i.e., number of total groups minus one). For instance, if there are 9 groups, then the gap between two adjacent transmitter-receiver pairs is up to 8.

A key point is that only one group is on at any time. Thus, emitted light from an active transmitter may only be received by its paired receiver on the opposite side of the touch screen since adjacent receivers to the active transmitter-receiver pair are in other groups and therefore not active.

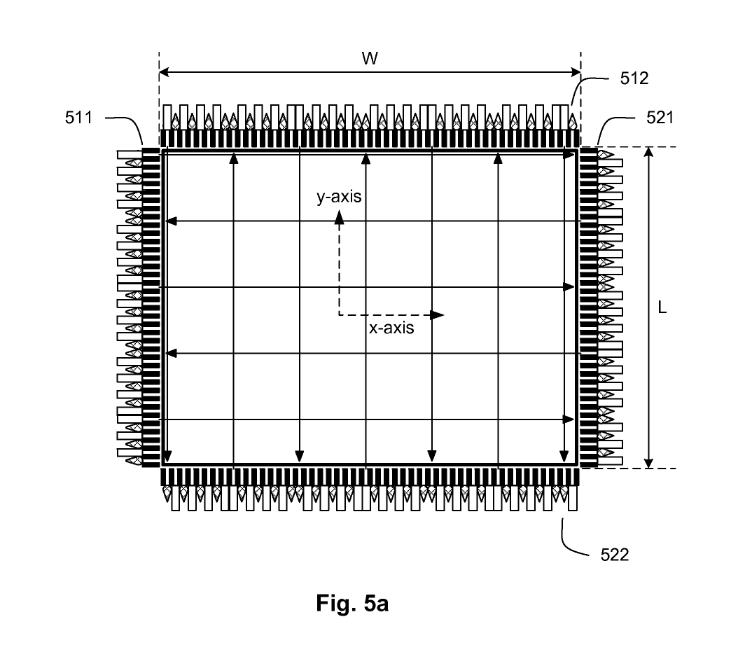

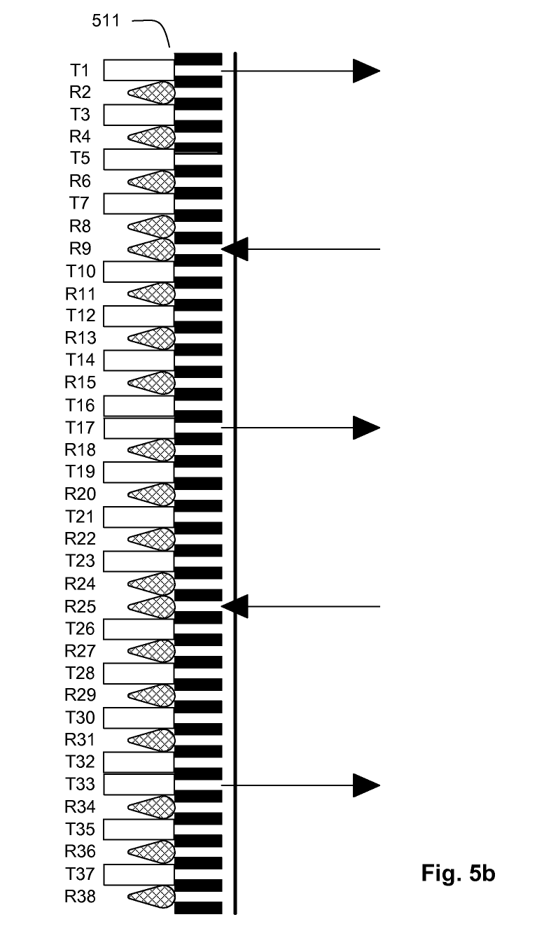

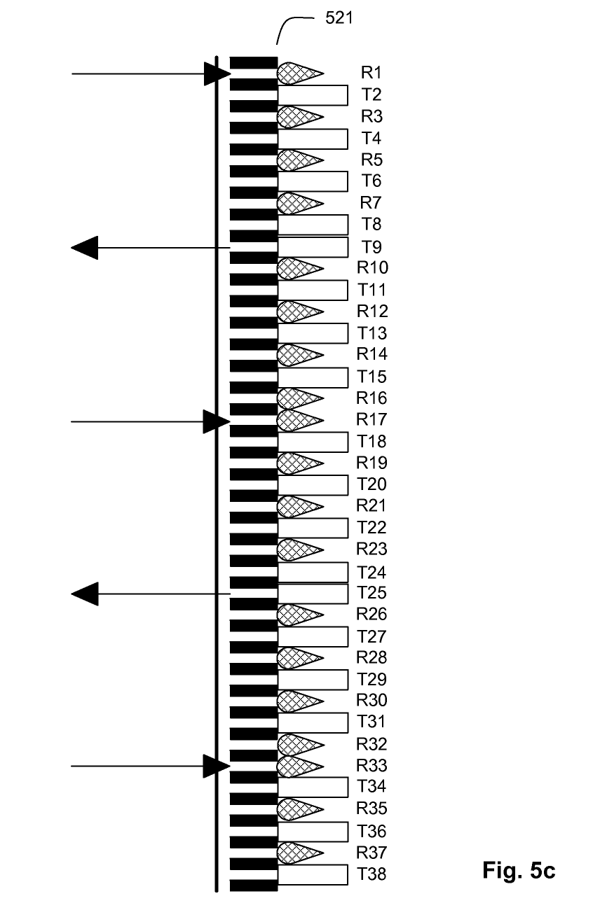

FIGS. 5a-5c illustrate an optical touch screen in accordance with a grouping scheme, an alternating scheme, and light guides for detecting objects on or in close proximity to the touch sensitive area of the touch screen. Transmitter-receiver pairs are arranged along each side (i.e., 511, 521, 512, and 522) of the touch screen according to a reverse alternating order and partitioned into groups as a function of the position of each of the transmitter-receiver pair on the sides 511, 521, 512, and 522 of the touch screen. The position of a transmitter-receiver pair can be indicated by the position of the transmitter-receiver pair along one of the sides. Additionally, the position can be represented by numbering the transmitter-receiver pairs in sequential order, starting from one of the ends of a side. To summarize, sequential transmitter-receiver pairs are assigned to different groups, such that each group has transmitter-receiver pairs that are a predefined number of positions from each other.

For instance, on the left side 511 of the touch screen (illustrated in FIG. 5b), the order from the top to the bottom is the following of a transmitter T1, a receiver R2, a transmitter T3, a receiver R4, a transmitter T5, a receiver R6, a transmitter T7, a receiver R8, then the order reverses with a receiver R9 next, a transmitter T10, a receiver R11, and so on where the order reverses every 8 positions.

The transmitters and receivers along a side can be partitioned according to their sequential order. For instance, if eight groups are used and the group order is group 1, group 2, group 3, group 4, group 5, group 6, group 7, and group 8, then, on the left side 511, the transmitter T1 is assigned to group 1, the receiver R2 is assigned to group 2, the transmitter T3 is assigned to group 3, the receiver R4 is assigned to group 4, the transmitter T5 is assigned to group 5, the receiver R6 is assigned to group 6, the transmitter T7 is assigned to group 7, the receiver R8 is assigned to group 8, then groups start back at group 1 with the receiver R9 assigned to group 1, the transmitter T10 is assigned to group 2, the receiver R11 is assigned to group 3, and so on until all the receivers and transmitters on the left side are assigned a group.

Under this scheme, the following transmitters and receivers on the left side 511 of T1, R9, T17, R25, and T33 are in the same group (as well as their paired transmitters and receivers on the right side 521). Furthermore, the top side 512 and the bottom side 522 of the touch screen are partitioned into groups in a similar manner.

In total for each of the assigned groups, there are 4 or 5 light beams traveling between the left side 511 and the right side 521 (i.e., 4 or 5 transmitter-receiver pairs assigned to that group) and 6 or 7 light beams traveling between the top side 512 and the bottom side 522 (i.e., 6 or 7 transmitter-receiver pairs assigned to that group). Thus, when one group is activated, 10 to 12 beams are simultaneously active at any single instant in time. The activated group forms a grid of light beams on the detection area.

In addition, the alternating scheme may reverse the arrangement of transmitters and receivers after a certain number of alternating transmitters and receivers (see FIG. 3d for an illustration) to insure that active beams in the same emitting direction are maintained at a maximum distance from each other and to maintain a crossing beam pattern on the detection area.

As stated earlier, a transmitter may emit light with some angle spread. For instance, in the worst case scenario, the left transmitter T1 may emit light at various angles and be incident on the right receiver R17, which is in the same group, assuming the view angle of transmitter is +/−25°.

Thus, there can be light guides in front of the transmitters and receivers. For instance, a light guide can be used to limit the light received by the right receiver R17 to prevent such extraneous light at certain angles. The light guide has a defined size to limit the angle of the light, such that the light emitted from the left transmitter T1 may not be incident on the right receiver R17.

The number of groups can be selected based on the dimensions of the touch screen.

First, the minimal number of groups can be selected based on the given dimensions of a touch screen. On the left side 511 and the right side 521, the minimum number of adjacent transmitters and receivers that must be deactivated between two active adjacent transmitter-receiver pairs in the same emitting direction is

Ny=INT((L+D)*d1/(D*d2)). (1)

Along the top side 512 and the bottom side 522, the minimum number of adjacent transmitters and receivers that must be deactivated between two active adjacent transmitter-receiver pairs in the same emitting direction is

Nx=INT((W+D)*d1/(D*d2)). (2)

Therefore, the minimal number of groups for all directions is

N=INT((LEN+D)*d1/(2*D*d2))+1, where LEN=MAX(L,W). (3)

For instance, assume an active display has a detection area of 150 mm by 114 mm with a target resolution of about 3 mm by 3 mm (e.g., much smaller than the size of a human's finger, which is at least 6 mm by 6 mm for a child's finger). In order for such a resolution, at least 50 light beams (150 mm/3 mm) are needed to determine the x-axis location of an object on or in proximity to the touch screen and 38 light beams (114 mm/3 mm) are needed to determine the y-axis location of the object on or in proximity to the touch screen. Referring to FIG. 5a, the lines with arrows represent the light beams with their emitting directions, where at any moment only a selected group of transmitters and receivers are active (i.e., on).

On the top side 512 of the touch screen, there are 25 receivers and 25 transmitters. On the bottom side 522 of the touch screen, there are also 25 transmitters and 25 receivers, which are paired to the transmitters and receivers on the top side 512.

The positions of the transmitter and receiver pairs should be substantially aligned along a line in the same plane as the detection area, such that the light from a transmitter can reach its paired receiver. In total, there are 50 transmitter-receiver pairs on the top side 512 of the touch screen and the bottom side 522 of the touch screen for detecting an object. Along the same vein, there are 38 transmitter-receiver pairs along the left side 511 and the right side 521 of the touch screen for detecting an object. The total number of beams is dependent on the desired resolution of the touch screen and the physical dimensions of the touch sensitive area of the touch screen.

All the beams that are activated at the same instant in time can be referred to as a group. The number of groups can be based on roughly a half of the minimum number of transmitter and receiver positions to deactivate between two active adjacent transmitter-receiver pairs in the same emitting direction on a single side.

A minimal number of transmitter and receiver positions to skip can be determined by inputting the corresponding dimensions of the touch screen to Equations (1) and (2) and (3), given D=4 mm, d1=1 mm, d2=3 mm, W=150 mm, L=114 mm, thus LEN=MAX(L,W)=W=150 mm: Ny=INT((L+D)*d1/(D*d2))=INT((114+4)*1/(4*3))=9; and Nx=INT ((W+D)*d1/(D*d2))=INT((150+4)*1/(4*3))=12. Therefore, N=INT((LEN+D)*d1/(2*D*d2))+1=INT((150+4)*1/(2*4*3))+1=7 for all directions.

Therefore, at least 9 adjacent transmitter-receiver pairs can be skipped along the left side 511 and the right side 521 and at least 12 adjacent transmitter-receiver pairs can be skipped along the top side 512 and the bottom side 522. For instance, for the transmitter T1 on the left side 511, its emitted light may reach several receivers on the right side 521, such as R1 (the paired receiver for T1), R3, R5, R7, R10, R12. Also, for the transmitter T9 on the right side 521, its emitted light may reach several receivers on the left side 511, such as R2, R4, R6, R8 (4 receivers before R9 along the left side), R9 (the paired receiver for T9), R11, R13, R15, R18, R20 (5 receivers after R9 along the left side). In order to prevent that light from hitting other receivers other than R9, a group number of 8 can be implemented so that when the transmitter-receiver pair of T9 and R9 is active, then its adjacent transmitter-receiver pairs that are in the other 7 groups are inactive.

Also, a transparent dust cover can be used to cover the light guides. Furthermore, the dust cover can be selected such that the cover has a high transmission rate and a low refraction rate for minimizing light reflection.

In another embodiment of the invention, a grouping scheme can be used without having light guides and/or an alternating scheme. If an alternating scheme is not employed, then the grouping scheme can be selected such that the minimum number of groups is the maximum of Nx and Ny from Equation (1) and Equation (2). The reason for taking the maximum of Nx and Ny is that the transmitter-receiver pairs in the same group are transmitting in the same direction, thus need to have a group number that can give this maximum distance between activated transmitter-receiver pairs in the same group.

Whereas when there is an alternating scheme, the minimum number of groups can be smaller than the maximum of Nx and Ny from Equation (1) and Equation (2) since any two adjacent activated beams of the same group along the touch sensitive area are emitted in opposite directions, thus do not interfere with each others reception.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A touch screen system, comprising:
a detection area having at least two sides;
light transmitters (“LTs”) disposed on the sides; and
light receivers (“LRs”) disposed on the sides,
wherein the LTs and the LRs are paired where one of the LTs is paired with one of the LRs, forming transmitter-receiver pairs,
wherein the transmitter-receiver pairs are positioned on the sides, where the light transmitter and the light receiver of anyone of the transmitter-receiver pairs are disposed on different ones of the sides,
wherein selected ones of the transmitter-receiver pairs are partitioned into two or more groups as a function of the respective positions of the transmitter-receiver pairs along the sides, and
wherein one of the groups is activated at a given time.

2. The touch screen system of claim 1 wherein the transmitter-receiver pairs are assigned to different groups where each group has transmitter-receiver pairs that are a predefined number of positions from each other.

3. The touch screen system of claim 2 wherein the groups are activated as a function of the sequential positions of the transmitter-receiver pairs.

4. The touch screen system of claim 1 wherein the activated group forms a grid of light beams.

5. The touch screen system of claim 4 wherein adjacent light beams of the grid emit in opposite directions.

6. The touch screen system of claim 1 wherein the groups are activated according to a group order.

7. The touch screen system of claim 1 wherein light guides are disposed between the LTs and the detection area and disposed between the LRs and the detection area.

8. The touch screen system of claim 7
wherein each of the light guides having an entry area with a length (“D”) and a width (“d1”),
wherein at least one of the sides having a maximum length (“L”) of all sides,
wherein the length is partitioned into a plurality of slots having a segment length (“d2”) for placing one of the LTs or one of the LRs, and
wherein a minimum number of the groups is, N=INT((L+D)*d1/(2*D*d2))+1.

9. The touch screen system of claim 1 wherein the LTs and the LRs are positioned in alternating order along the sides.

10. The touch screen system of claim 1 wherein the LTs and the LRs are positioned according to a reverse-alternating order along the sides.

11. A method for managing a touch screen, comprising:
determining a detection area having at least two sides;
disposing the light transmitters (“LTs”) on the sides;
disposing the light receivers (“LRs”) on the sides;
forming transmitter-receiver pairs, wherein one of the LTs is paired with one of the LRs;
positioning the transmitter-receiver pairs on the sides, wherein the light transmitter and the light receiver of anyone of the transmitter-receiver pairs are disposed on different ones of the sides;
partitioning the transmitter-receiver pairs into two or more groups as a function of the respective positions of the transmitter-receiver pairs along the sides; and
activating one of the groups at a given time.

12. The method for managing a touch screen of claim 11 in the partitioning step, wherein the transmitter-receiver pairs are assigned to different groups where each group has transmitter-receiver pairs that are a predefined number of positions from each other.

13. The method for managing a touch screen of claim 12 in the activating step, wherein the groups are activated as a function of the sequential positions of the transmitter-receiver pairs.

14. The method for managing a touch screen of claim 11 in the activating step, wherein the activated group forms a grid of light beams.

15. The method for managing a touch screen of claim 14 in the activating step, wherein adjacent light beams of the grid emit in opposite directions.

16. The method for managing a touch screen of claim 11 in the activating step, wherein the groups are activated according to a group order.

17. The method for managing a touch screen of claim 11 further comprising the step after the disposing light receivers step, disposing light guides between the LTs and the detection area and between the LRs and the detection area.

18. The method for managing a touch screen of claim 17 in the disposing light guides step,
wherein each of the light guides having an entry area with a length (“D”) and a width (“d1”),
wherein at least one of the sides having a maximum length (“L”) of all sides,
wherein the length is partitioned into a plurality of slots having a segment length (“d2”) for placing one of the LTs or one of the LRs, and
wherein a minimum number of the groups is, N=INT((L+D)*d1/(2*D*d2))+1.

19. The method for managing a touch screen of claim 11 wherein the LTs and the LRs are positioned in alternating order along the sides.

20. The method for managing a touch screen of claim 11 wherein the LTs and the LRs are positioned according to a reverse-alternating order along the sides.
